(19) United States
(12) Patent Application Publication
(10) Pub. No.: US 2017/0097627 A1
(43) Pub. Date: Apr. 6, 2017

(54) SAFETY SWITCH SYSTEM

(71) Applicant: Southwire Company, LLC, Carrollton, GA (US)

(72) Inventors: Timmothy Bardin, Carrollton, GA (US); Thomas J. Caldwell, Jacksonville Beach, FL (US)

(73) Assignee: Southwire Company, LLC, Carrollton, GA (US)

(21) Appl. No.: 15/283,652

(22) Filed: Oct. 3, 2016

Related U.S. Application Data
(60) Provisional application No. 62/236,262, filed on Oct. 2, 2015.

(51) Int. Cl. G05B 19/042; H02G 1/08; H01H 3/16; H01H 3/14; H01H 3/12

(52) U.S. Cl. CPC G05B 19/0428; H01H 3/14; H01H 3/12; H01H 3/16; H02G 1/081; G05B 2219/24024

(57) ABSTRACT

A cable pulling system may be provided. The cable pulling system may comprise a cable puller, a cable feeder located remotely from the cable puller, a puller end switch located at the cable puller, and a feeder end switch located at the cable feeder. The puller end switch may have a puller end switch trigger. The puller end switch may be configured to stop the cable puller and the cable feeder when the puller end switch trigger is actuated. The feeder end switch may have a feeder end switch trigger. The feeder end switch may be configured to stop the cable puller and the cable feeder when the feeder end switch trigger is actuated.

### RELATED APPLICATION

Under provisions of 35 U.S.C. §119(e), Applicants claim the benefit of U.S. provisional application Ser. No. 62/236,262 filed Oct. 2, 2015, which is incorporated herein by reference.

### BACKGROUND

An electrical conduit is a tube used to protect and route electrical wiring in a building or non-building structure. Electrical conduit may be made of metal, plastic, fiber, or fired clay. Most conduit is rigid, but flexible conduit is used for some purposes. Conduit is generally installed by electricians at the site of installation of electrical equipment. Its use, form, and installation details are often specified by wiring regulations, such as the US National Electrical Code (NEC) and other building codes.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of a cable pulling environment;

FIG. 2 is a block diagram of a cable pulling control system;

FIG. 3 is a flow chart of a method for controlling a cable pulling environment;

FIG. 4 is a block diagram of a computing device; and

FIG. 5A, FIG. 5B, and FIG. 5C show a plurality of indicators.

### DETAILED DESCRIPTION

### Overview

A cable pulling system may be provided. The cable pulling system may comprise a cable puller, a cable feeder located remotely from the cable puller, a puller end switch located at the cable puller, and a feeder end switch located at the cable feeder. The puller end switch may have a puller end switch trigger. The puller end switch may be configured to stop the cable puller and the cable feeder when the puller end switch trigger is actuated. The feeder end switch may have a feeder end switch trigger. The feeder end switch may be configured to stop the cable puller and the cable feeder when the feeder end switch trigger is actuated.

Both the foregoing overview and the following example embodiment are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiment.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Embodiments of the disclosure may provide a way to incorporate safety features while pulling cable through a conduit on a jobsite. With embodiments of the disclosure, aspects (e.g., stopping) of a cable pull may be controlled from any location with foot switches and through hand held remote pendants (e.g., remote switches) to a master foot switch.

Conventional pulling processes may be controlled by voice commands and communication over hand held radios or cell phones. These voice commands may be directed to operators who must hear the voice command, mentally process the voice command, and manually stop the cable pull in response to the mentally processed voice command. There may be times, however, when conventional communication may be interrupted either by noise on a jobsite or a misunderstanding of the conventional communications being transmitted. This interruption may result in injuries. Embodiments of the disclosure may provide a way to stop a cable pull, for example, by pushing a button or lifting a foot off a foot switch at locations along the cable pull by technicians who are observing the cable pull for any safety issues. Consequently, embodiments of the disclosure may eliminate the communication interruption problems.

Safety may be improved by embodiments of the disclosure by using, for example, a plurality of handheld control pendants (e.g., switches) that may be located at different positions along a cable pull in order to stop the cable pull if an unsafe condition arises with the cable or personnel anywhere along the pulling path. With controllable electrical power receptacles on, for example, a switch, cable pulling equipment (e.g., cable pullers and cable feeders) may be controlled. Embodiments of the disclosure may stop a cable pull, for example, within 200 milliseconds, which may be faster than relaying voice commands in conventional processes.

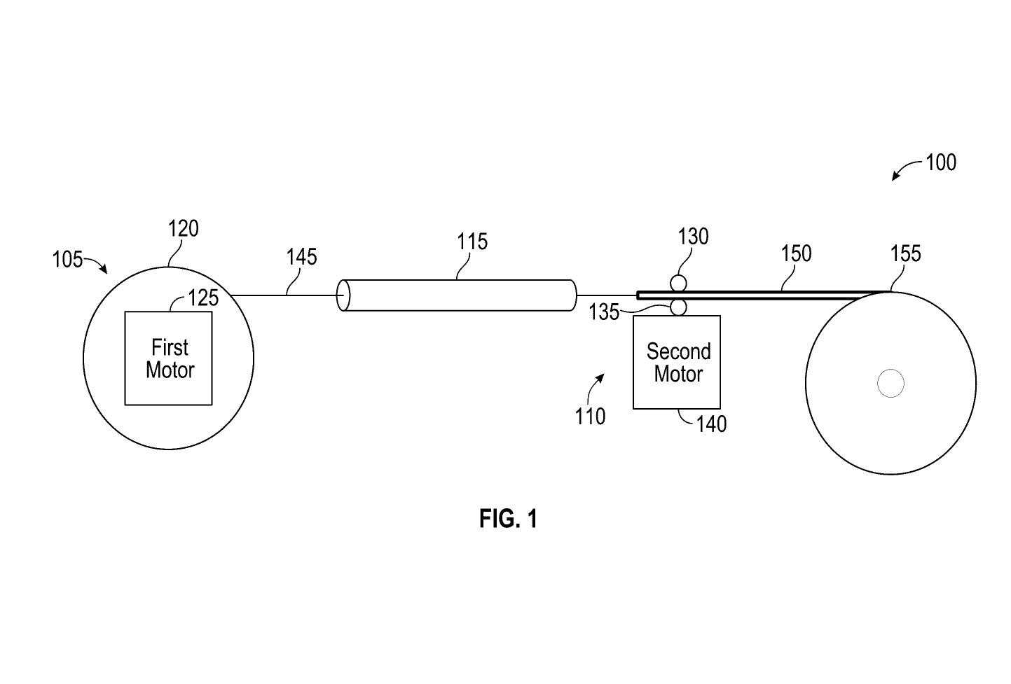

FIG. 1 is a block diagram of a cable pulling environment 100 in accordance with embodiments of the disclosure. As shown in FIG. 1, operating environment 100 may comprise a cable puller 105, a cable feeder 110, and a conduit 115. Cable puller 105 may comprise a capstan 120 and a first motor 125. Cable feeder 110 may comprise a first roller 130, a second roller 135, and a second motor 140.

In order to perform a cable pull, a rope 145 may be attached to a cable 150 pulled from a reel 155. Rope 145 may be blown into conduit 115 from the cable feeder 110 end of conduit 115 to the cable puller 105 end of conduit 115. Rope 145 may then be attached to capstan 120. First motor 125 may cause capstan 120 to rotate and wind rope 145 onto capstan 120. As rope 145 is wound onto capstan 120, cable 150 follows rope 145 into and through conduit 115.

Cable feeder 110 may assist in the cable pull by feeding (e.g., pushing) cable 150 into conduit 115. For example, first roller 130 and second roller 135 may slightly pinch cable 150 between first roller 130 and second roller 135. Second motor 140 may cause first roller 130 and second roller 135 to rotate in a direction configured to feed (e.g., push) cable 150 into conduit 115. The actions of cable puller 105 and cable feeder 110 may be coordinated so that cable puller 105 may pull cable 150 into conduit 115 while cable feeder 110 simultaneously feeds cable 150 into conduit 115.

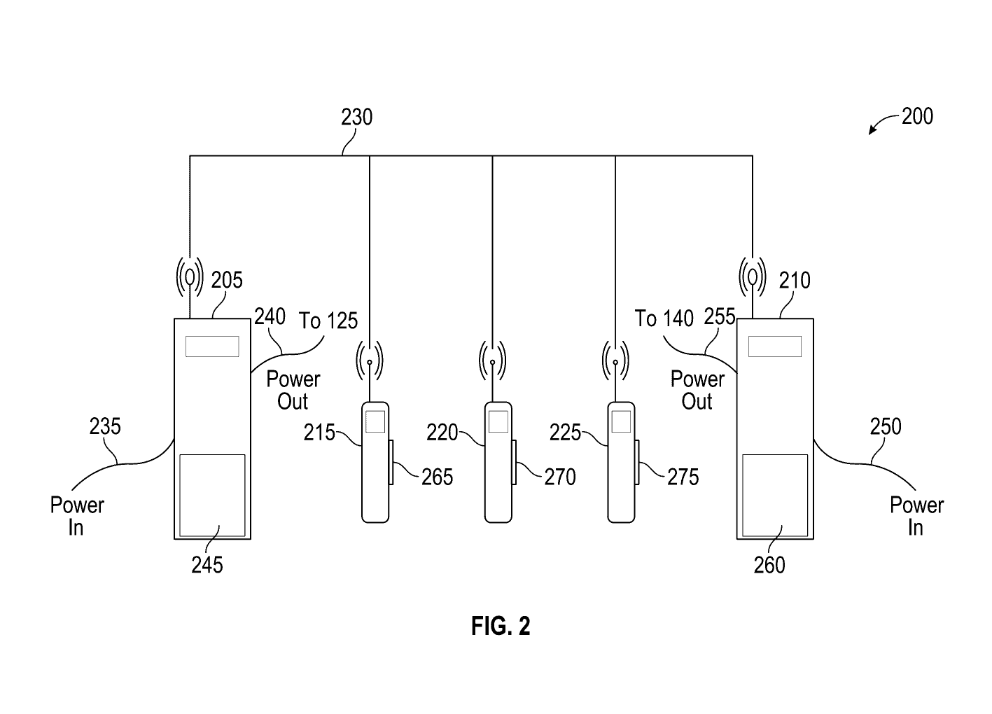

FIG. 2 shows a cable pulling control system 200. As shown in FIG. 2, cable pulling control system 200 may comprise a puller end switch 205, a feeder end switch 210, a plurality of remote switches (e.g., a first remote switch 215, a second remote switch 220, and a third remote switch 225), and a communications link 230.

Puller end switch 205 may comprise a cable puller power input 235, a cable puller power output 240, and a puller end switch trigger 245. Feeder end switch 210 may comprise a cable feeder power input 250, a cable feeder power output 255, and a feeder end switch trigger 260. First remote switch 215 may comprise a first remote switch trigger 265, second remote switch 220 may comprise a second remote switch trigger 270, and third remote switch 225 may comprise a third remote switch trigger 275. Each of puller end switch 205, feeder end switch 210, and the plurality of remote switches may communicate with each other over communications link 230. Communications link 230 may be wireless or wired. Puller end switch trigger 245 may comprise, but is not limited to, a “Deadman's” switch. Feeder end switch trigger 260 may comprise, but is not limited to, a “Deadman's” switch.

Cable puller power input 235 of puller end switch 205 may be connected to an electrical power source, for example, to a 110V or a 220V electrical power source. This electrical power source may be passed through puller end switch 205 and supplied to first motor 125 through cable puller power output 240. For example, puller end switch 205 may include an electrical receptacle (e.g., to feed cable puller power output 240) to which first motor may be plugged into for electrical power. This receptacle may be supplied by cable puller power input 235. Puller end switch 205 may include and control a puller end switch breaker (or other circuit interrupting device) that, when closed, causes cable puller power input 235 to supply cable puller power output 240 with electrical power. When opened, puller end switch breaker may cause cable puller power input 235 to no longer supply cable puller power output 240 with electrical power.

Cable feeder power input 250 of feeder end switch 210 may be connected to an electrical power source, for example, to a 110V or a 220V electrical power source. This electrical power source may be passed through feeder end switch 210 and supplied to second motor 140 through cable feeder power output 255. For example, feeder end switch 210 may include an electrical receptacle (e.g., to feed cable feeder power output 255) to which second motor 140 may be plugged into for electrical power. This receptacle may be supplied by cable feeder power input 250. Feeder end switch 210 may include and control a feeder end switch breaker (or other circuit interrupting device) that, when closed, causes cable feeder power input 250 to supply cable feeder power output 255 with electrical power. When opened, feeder end switch breaker may cause cable feeder power input 250 to no longer supply cable feeder power output 255 with electrical power.

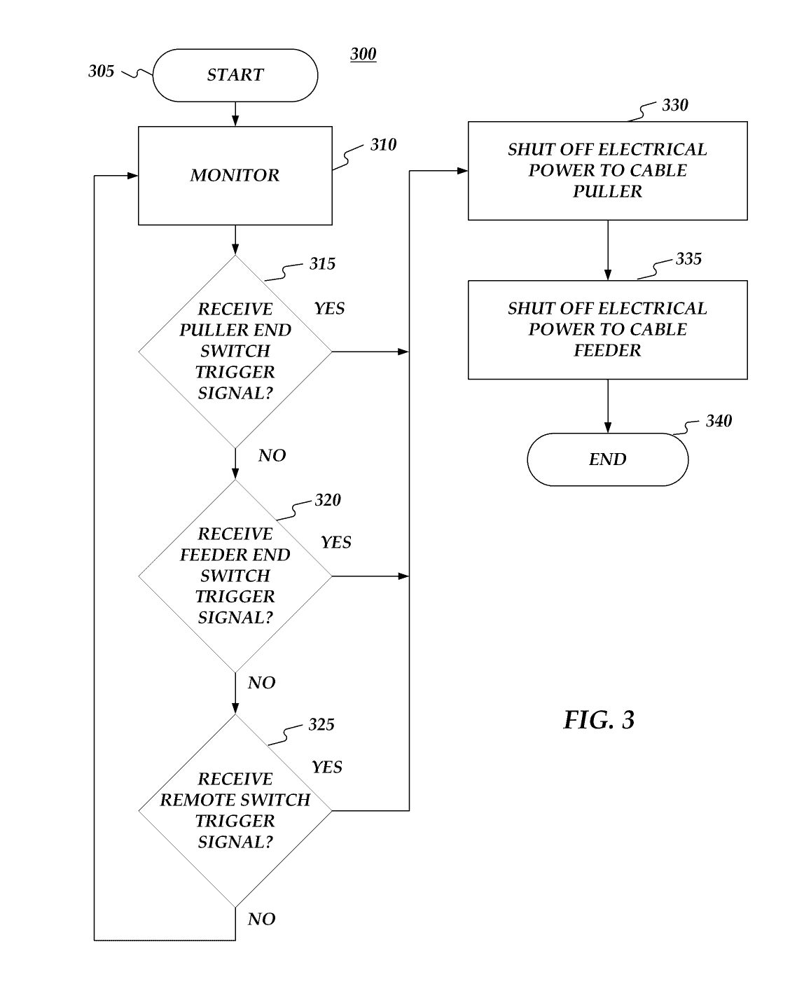

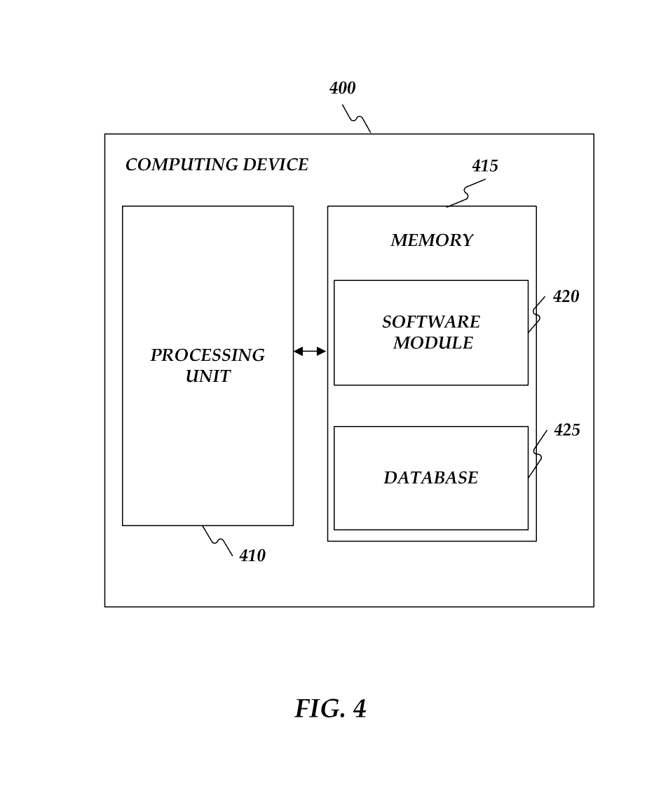

FIG. 3 is a flow chart setting forth the general stages involved in a method 300 consistent with embodiments of the disclosure for controlling a cable pulling environment. Method 300 may be implemented using a computing device 400 as described in more detail below with respect to FIG. 4. Ways to implement the stages of method 300 will be described in greater detail below.

Method 300 may begin at starting block 305 and proceed to stage 310 where computing device 400 may monitor for switch trigger signals. While computing device 400 may be disposed in puller end switch 205, feeder end switch 210, or any of the plurality of remote switches, computing device 400 may be disposed anywhere and is not limited to being disposed in puller end switch 205, feeder end switch 210, or any of the plurality of remote switches. Computing device 400 may continuously wait to receive a trigger signal from any of puller end switch 205, feeder end switch 210, or any of the plurality of remote switches, for example, via communications link 230.

From stage 310, where computing device 400 monitors for switch trigger signals, method 300 may advance to decision block 315 where computing device 400 may determine if it received a puller end switch trigger signal (e.g., from puller end switch 205). If computing device 400 did not receive the puller end switch trigger signal at decision block 315, method 300 may continue to decision block 320 where computing device 400 may determine if it received a feeder end switch trigger signal (e.g., from feeder end switch 210). If computing device 400 did not receive the feeder end switch trigger signal at decision block 320, method 300 may continue to decision block 325 where computing device 400 may determine if it received a remote switch trigger signal (e.g., from any one of the plurality of remote switches). If computing device 400 did not receive the remote switch trigger signal at decision block 325, method 300 may proceed back to stage 310 where computing device 400 may monitor for switch trigger signals.

However, if computing device 400 received a puller end switch trigger signal at decision block 315, a feeder end switch trigger signal at decision block 320, or a remote switch trigger signal at decision block 325, method 300 may proceed to stage 330 where computing device 400 may shut off electrical power to cable puller 105. For example, computing device 400 may shut off electrical power to cable puller 105 by causing the puller end switch breaker to open, thus causing cable puller power input 235 to no longer supply cable puller power output 240 with electrical power from which first motor 125 may be fed with electrical power.

A first operator may be observing cable puller 105 in operation as cable puller 105 winds rope 145 onto capstan 120 during a cable pulling operation of operating environment 100. Puller end switch trigger 245 may comprise a foot pedal that is being depressed by the first operator (e.g., by the first operator's foot). As long as the first operator keeps puller end switch trigger 245 depressed, no puller end switch trigger signal may be transmitted by puller end switch 205. However, the first operator may observe an issue with the cable pulling operation (e.g., at the cable puller 105 end of operating environment 100). In response, the first operator may actuate puller end switch trigger 245, for example, by removing his foot from puller end switch trigger 245.

Once puller end switch trigger 245 is actuated, the puller end switch trigger signal may be transmitted to computing device 400. After the puller end switch trigger signal is received by computing device 400, computing device 400 may shut off electrical power to cable puller 105. Computing device 400 may, for example, shut off electrical power to cable puller 105 by causing the puller end switch breaker to open, thus causing cable puller power input 235 to no longer supply cable puller power output 240 with electrical power from which first motor 125 may be fed with electrical power.

The puller end switch trigger signal may be transmitted to and received by computing device 400 over communications link 230. Or the puller end switch trigger signal may be transmitted to and received by computing device 400 over a directly connected electrical path (e.g., a wire).

Furthermore, computing device 400 may shut off electrical power to cable puller 105 when computing device 400 receives a feeder end switch trigger signal when feeder end switch trigger 260 is actuated. A second operator may be observing cable feeder 110 in operation as cable feeder 110 feeds cable 150 into conduit 115 during the cable pulling operation of operating environment 100. Feeder end switch trigger 260 may comprise a foot pedal that is being depressed by the second operator (e.g., by the second operator's foot). As long as the second operator keeps feeder end switch trigger 260 depressed, no feeder end switch trigger signal may be transmitted by feeder end switch 210. However, the second operator may observe an issue with the cable pulling operation (e.g., at the cable feeder 110 end of operating environment 100). In response, the second operator may actuate feeder end switch trigger 260, for example, by removing his foot from feeder end switch trigger 260.

Once feeder end switch trigger 260 is actuated, the feeder end switch trigger signal may be transmitted to computing device 400. After the feeder end switch trigger signal is received by computing device 400, computing device 400 may shut off electrical power to cable puller 105. Computing device 400 may, for example, shut off electrical power to cable puller 105 by causing the puller end switch breaker to open, thus causing cable puller power input 235 to no longer supply cable puller power output 240 with electrical power from which first motor 125 may be fed with electrical power.

The feeder end switch trigger signal may be transmitted to and received by computing device 400 over communications link 230. Or the feeder end switch trigger signal may be transmitted to and received by computing device 400 over a directly connected electrical path (e.g., a wire).

In addition to the first operator and the second operator, a plurality of other operators may also be observing the cable pulling operation of operating environment 100. The plurality of other operators may be located at various point in operating environment 100 and correspondingly supplied with ones of the plurality remote switches. For example, a one of the plurality of other operators may be assigned first remote switch 215. The one of the plurality of other operators may observe an issue with the cable pulling operation (e.g., anywhere in operating environment 100). In response, the one of the plurality of other operators may actuate first remote switch trigger 265, for example, by depressing first remote switch trigger 265.

Once first remote switch trigger 265 is actuated, the first remote switch trigger signal may be transmitted to computing device 400 by first remote switch 215. After the first remote switch trigger signal is received by computing device 400, computing device 400 may shut off electrical power to cable puller 105. Computing device 400 may, for example, shut off electrical power to cable puller 105 by causing the puller end switch breaker to open, thus causing cable puller power input 235 to no longer supply cable puller power output 240 with electrical power from which first motor 125 may be fed with electrical power.

The first remote switch trigger signal may be transmitted to and received by computing device 400 over communications link 230. Or the first remote switch trigger signal may be transmitted to and received by computing device 400 over a directly connected electrical path (e.g., a wire). Consequently, if the first operator, the second operator, or any of the plurality of other operators observes an issue with the cable pulling operation of operating environment 100, any of the first operator, the second operator, or the plurality of other operators may cause cable puller 105 to stop.

After computing device 400 shuts off electrical power to cable puller 105 in stage 330, method 300 may proceed to stage 335 where computing device 400 may shut off electrical power to cable feeder 110. Computing device 400 may shut off electrical power to cable feeder 110 at substantially the same time as it shuts off electrical power to cable puller 105. In other words, the puller end switch trigger signal, the feeder end switch trigger signal, or the remote switch trigger signal may also cause computing device 400 to shut off electrical power to cable feeder 110. For example, computing device 400 may shut off electrical power to cable feeder 110 by causing the feeder end switch breaker to open, thus causing cable feeder power input 250 to no longer supply cable puller power output 255 with electrical power from which second motor 140 may be fed with electrical power.

As described above, a first operator may be observing cable puller 105 in operation as cable puller 105 winds rope 145 onto capstan 120 during a cable pulling operation of operating environment 100. Puller end switch trigger 245 may comprise a foot pedal that is being depressed by the first operator (e.g., by the first operator's foot). As long as the first operator keeps puller end switch trigger 245 depressed, no puller end switch trigger signal may be transmitted by puller end switch 205. However, the first operator may observe an issue with the cable pulling operation (e.g., at the cable puller 105 end of operating environment 100). In response, the first operator may actuate puller end switch trigger 245, for example, by removing his foot from puller end switch trigger 245.

Once puller end switch trigger 245 is actuated, the puller end switch trigger signal may be transmitted to computing device 400. After the puller end switch trigger signal is received by computing device 400, computing device 400 may shut off electrical power to cable feeder 110. For example, computing device 400 may shut off electrical power to cable feeder 110 by causing the feeder end switch breaker to open, thus causing cable feeder power input 250 to no longer supply cable puller power output 255 with electrical power from which second motor 140 may be fed with electrical power.

The puller end switch trigger signal may be transmitted to and received by computing device 400 over communications link 230. Or the puller end switch trigger signal may be transmitted to and received by computing device 400 over a directly connected electrical path (e.g., a wire).

Furthermore, computing device 400 may shut off electrical power to cable feeder 110 when computing device 400 receives a feeder end switch trigger signal when feeder end switch trigger 260 is actuated as described above. A second operator may be observing cable feeder 110 in operation as cable feeder 110 feeds cable 150 into conduit 115 during the cable pulling operation of operating environment 100. Feeder end switch trigger 260 may comprise a foot pedal that is being depressed by the second operator (e.g., by the second operator's foot). As long as the second operator keeps feeder end switch trigger 260 depressed, no feeder end switch trigger signal may be transmitted by feeder end switch 210. However, the second operator may observe an issue with the cable pulling operation (e.g., at the cable feeder 110 end of operating environment 100). In response, the second operator may actuate feeder end switch trigger 260, for example, by removing his foot from feeder end switch trigger 260.

Once feeder end switch trigger 260 is actuated, the feeder end switch trigger signal may be transmitted to computing device 400. After the feeder end switch trigger signal is received by computing device 400, computing device 400 may shut off electrical power to cable feeder 110. Computing device 400 may, for example, shut off electrical power to cable feeder 110 by causing the feeder end switch breaker to open, thus causing cable feeder power input 250 to no longer supply cable puller power output 255 with electrical power from which second motor 140 may be fed with electrical power.

The feeder end switch trigger signal may be transmitted to and received by computing device 400 over communications link 230. Or the feeder end switch trigger signal may be transmitted to and received by computing device 400 over a directly connected electrical path (e.g., a wire).

In addition to the first operator and the second operator, a plurality of other operators may also be observing the cable pulling operation of operating environment 100 as described above. The plurality of other operators may be located at various point in operating environment 100 and correspondingly supplied with ones of the plurality remote switches. For example, a one of the plurality of other operators may be assigned first remote switch 215. The one of the plurality of other operators may observe an issue with the cable pulling operation (e.g., anywhere in operating environment 100). In response, the one of the plurality of other operators may actuate first remote switch trigger 265, for example, by depressing first remote switch trigger 265.

Once first remote switch trigger 265 is actuated, the first remote switch trigger signal may be transmitted to computing device 400 by first remote switch 215. After the first remote switch trigger signal is received by computing device 400, computing device 400 may shut off electrical power to cable feeder 110. Computing device 400 may, for example, shut off electrical power to cable feeder 110 by causing the feeder end switch breaker to open, thus causing cable feeder power input 250 to no longer supply cable puller power output 255 with electrical power from which second motor 140 may be fed with electrical power.

The first remote switch trigger signal may be transmitted to and received by computing device 400 over communications link 230. Or the first remote switch trigger signal may be transmitted to and received by computing device 400 over a directly connected electrical path (e.g., a wire). Consequently, if the first operator, the second operator, or any of the plurality of other operators observes an issue with the cable pulling operation of operating environment 100, any of the first operator, the second operator, or the plurality of other operators may cause cable feeder 110 to stop. Once computing device 400 shut off electrical power to cable feeder 110 in stage 335, method 300 may then end at stage 340.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform processes for controlling a cable pulling environment, including for example, any one or more of the stages from method 300 described above with respect to FIG. 3. Computing device 400, for example, may be provided and operate within puller end switch 205, feeder end switch 210, or any one or more of the plurality of remote switches. Puller end switch 205, feeder end switch 210, and the plurality of remote switches may operate with other devices and is not limited to computing device 400.

Computing device 400 may be implemented using a Wi-Fi access point, a cellular base station, a tablet device, a mobile device, a smart phone, a telephone, a remote control device, a set-top box, a digital video recorder, a handheld scanner, a cable modem, a personal computer, a network computer, a mainframe, a router, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. Furthermore, computing device 400 may comprise, for example, a mobile terminal, such as a smart phone, a cellular telephone, a cellular telephone utilizing Wireless Application Protocol (WAP) or unlicensed mobile access (UMA), personal digital assistant (PDA), intelligent pager, portable computer, a hand held computer, a conventional telephone, or a Wireless Fidelity (Wi-Fi) access point. The aforementioned systems and devices are examples and computing device 400 may comprise other systems or devices.

While cable pulling systems were described above, embodiments of the disclosure may be used with any systems and are not limited to cable pulling systems. Embodiments of the disclosure may be used, for example, with any systems where safety is a concern and electrical equipment may need to be controlled. For example, embodiments of the invention may be used with electrically powered systems where components of the electrically powered systems may be remote from one another and safety concerns may exist at the components and between the components where shutting off the components may mitigate safety issues.

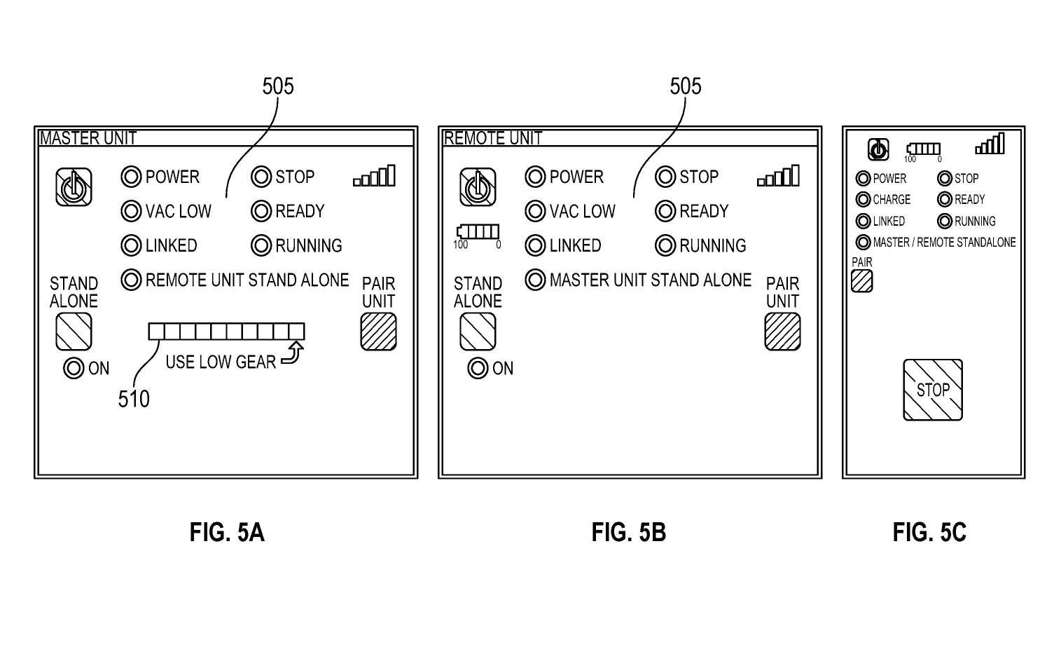

As shown in FIG. 5A, FIG. 5B, and FIG. 5C, embodiments of the disclosure may include a plurality of indicators that may address the condition, for example, of motors in cable pulling environment 100. These plurality of indicators many be included, for example, on any one or more of puller end switch 205, feeder end switch 210, and the plurality of remote switches (e.g., first remote switch 215, second remote switch 220, and third remote switch 225). For example, the plurality of remote switches may use, but are not limited to, the indicators shown in FIG. 5C. Puller end switch 205 and feeder end switch 210 may use, but are not limited to, the indicators shown in FIG. 5A and FIG. 5B.

One of the indicators may comprise a VAC Low indicator 505 (e.g. a light.) The VAC Low indicator 505 may indicate that there is not adequate voltage to ensure safe operation of the puller (e.g. first motor 125 or second motor 140.) When running a puller (e.g. first motor 125 or second motor 140) in a low voltage situation, the amount of current (i.e. amps) being drawn on the system increases and first motor 125 or second motor 140 may over heat and become damaged. VAC Low indicator 505 may help prevent this from happening by giving the operator an indication that this condition has occurred. Then the operator may fix this, for example, by addressing the source of power and or the size gauge extension cord being used to power the puller (e.g. first motor 125 or second motor 140.)

Another one of the indicators may comprise an amp/force gauge indicator 510 that may signal to the operator to switch the puller to a low gear. Amp/force gauge indicator 510 may progressively show how close the system is getting to a critical point by use of, for example, an LED strip, a needle, or pointer. Then, for example, when a red light comes on (e.g. at the end of an LED strip) in high speed, the operator may switch the puller to a lower speed to drop the current being drawn. In addition, embodiments of the disclosure may cut off the current to a motor when a predetermined amount of current is exceeded for a predetermined amount of time. For example, puller end switch 205 may monitor the level of current being drawn by first motor 125. If the monitored level of current exceeds a predetermined level for a predetermined period of time, then puller end switch 205 may cut off the current being supplied to first motor 125. The predetermined current and the predetermined time may be selected at levels to prevent damage to first motor 125. The other switchs may also include this functionality.

Embodiments of the disclosure may include the plurality of indicators without the switches (e.g. puller end switch 205, feeder end switch 210, and the plurality of remote switches) being connected by communications link 230. In other words, the switches may be standalone and may not be in communications with one another, but still include the plurality of indicators.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Moreover, the semantic data consistent with embodiments of the disclosure may be analyzed without being stored. In this case, in-line data mining techniques may be used as data traffic passes through, for example, a caching server or network router. Further, the disclosed methods stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the components illustrated in FIG. 2 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. An apparatus comprising:
a cable puller;
a cable feeder located remotely from the cable puller;
a puller end switch located at the cable puller, the puller end switch having a puller end switch trigger, the puller end switch configured to stop the cable puller and the cable feeder when the puller end switch trigger is actuated; and
a feeder end switch located at the cable feeder, the feeder end switch having a feeder end switch trigger, the feeder end switch configured to stop the cable puller and the cable feeder when the feeder end switch trigger is actuated.

2. The apparatus of claim 1, wherein the puller end switch trigger is actuated when the puller end switch trigger is released.

3. The apparatus of claim 1, wherein the feeder end switch trigger is actuated when the feeder end switch trigger is released.

4. The apparatus of claim 1, further comprising at least one remote switch comprising a remote switch trigger, wherein the at least one remote switch is configured to stop the cable puller and the cable feeder when the at least one remote switch trigger is actuated.

5. The apparatus of claim 4, wherein the at least one remote switch trigger is actuated when the least one remote switch trigger is pressed.

6. The apparatus of claim 4, wherein the puller end switch, the feeder end switch, and the at least one remote switch are configured to communicate over a wireless communication link.

7. The apparatus of claim 1, wherein the puller end switch and the feeder end switch are configured to communicate over a wireless communication link.

8. The apparatus of claim 1, wherein the cable puller is configured to pull a rope through a conduit.

9. The apparatus of claim 8, wherein the rope is connected to a cable.

10. The apparatus of claim 1, wherein the cable feeder is configured to feed a cable into a conduit.

11. A system comprising:
a memory storage; and
a processing unit coupled to the memory storage, wherein the processing unit is operative to:
receive at least one of the following: a puller end switch trigger signal when a puller end switch trigger is actuated and a feeder end switch trigger signal when a feeder end switch trigger is actuated; and
cause a puller end switch located at a cable puller to shut off electrical power to the cable puller in response to receiving at least one of the following:
the puller end switch trigger signal and the feeder end switch trigger signal.

12. The system of claim 11, wherein the puller end switch trigger is located on the puller end switch.

13. The system of claim 11, wherein the processing unit is further operative to cause a feeder end switch located at a cable feeder to shut off electrical power to the cable feeder in response to receiving at least one of the following: the puller end switch trigger signal and the feeder end switch trigger signal.

14. The system of claim 13, wherein the feeder end switch trigger is located on the feeder end switch.

15. The system of claim 13, wherein the processing unit is located in the feeder end switch.

16. The system of claim 11, wherein the processing unit is located in the puller end switch.

17. A method comprising:
receive at least one of the following: a puller end switch trigger signal when a puller end switch trigger is actuated and a feeder end switch trigger signal when a feeder end switch trigger is actuated; and
causing a puller end switch located at a cable puller to shut off electrical power to the cable puller in response to receiving at least one of the following: the puller end switch trigger signal and the feeder end switch trigger signal.

18. The method of claim 17, further comprising causing a feeder end switch located at a cable feeder to shut off electrical power to the cable feeder in response to receiving at least one of the following: the puller end switch trigger signal and the feeder end switch trigger signal.

19. The method of claim 18, further comprising receiving a remote switch trigger signal when a remote switch trigger is actuated.

20. The method of claim 19, further comprising causing the puller end switch to shut off electrical power to the cable puller in response to receiving the remote switch trigger signal.

21. The method of claim 19, further comprising causing the feeder end switch to shut off electrical power to the cable feeder in response to receiving the remote switch trigger signal.
